(19) United States
(12) Patent Application Publication
(10) Pub. No.: US 2003/0216917 A1
(43) Pub. Date: Nov. 20, 2003

(54) Voice interaction apparatus

(76) Inventors: Ryuji Sakunaga, Fukuoka (JP); Hideo Ueno, Fukuoka (JP); Yayoi Nakamura, Fukuoka (JP); Toshihiro Ide, Fukuoka (JP); Shingo Suzumori, Fukuoka (JP); Nobuyoshi Ninokata, Fukuoka (JP); Taku Yoshida, Fukuoka (JP); Hiroshi Sugitani, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/304,927

(22) Filed: Nov. 26, 2002

(30) Foreign Application Priority Data
May 15, 2002 (JP) 2002-139816

(51) Int. Cl. G10L 15/04

(52) U.S. Cl. 704/251

(57) ABSTRACT

In a voice interaction apparatus for performing voice response services utilizing voice, a voice recognizer detects an interaction response content (keywords, unnecessary words, unknown words, and silence) indicating a psychology of a voice-inputting person at a time of a voice interaction, an input state analyzer analyzes the interaction response content and classifies the psychology of the voice-inputting person into predetermined input state information, and a scenario analyzer selects a scenario for a voice-inputting person based on the input state information.

### BACKGROUND OF THE INVENTION

1. Field of the Invention

The present invention relates to a voice interaction apparatus, and in particular to a voice interaction apparatus which performs voice response services utilizing speech or voice.

Recently, commercialization utilizing technologies such as voice recognition, language analysis, and voice synthesis has improved. For example, a voice interaction apparatus (Voice Portal) which offers, by utilizing voice, information open to public on a Web site on the Internet has been briskly developed, so that a rapid growth in its future market is expected.

The voice interaction apparatus can contribute to remedy of a so-called digital divide that is one of issues in progress of IT, i.e. overcoming disparities in chance and ability of utilizing information communication technology based on age or physical conditions.

Furthermore, in the voice interaction apparatus, a certain inhibition for a mechanical operation can be regarded as a cause of a digital divide, so that it is important, for resolving the digital divide problem, to offer navigation services accepted by those who are not accustomed to the mechanical operation.

2. Description of the Related Art

FIG. 26 shows a prior art voice interaction apparatus 100z, which is provided with a voice recognizer 10z for inputting a voice signal 40z from a voice input portion 200, a voice authenticator 13z, a silence analyzer 14z, and a keyword analyzer 16z for respectively receiving voice data 42z, 43z, and keyword information 45z from the voice recognizer 10z.

Furthermore, the voice interaction apparatus 100z is provided with a scenario analyzer 21z for receiving individual identifying information 47z, silence analysis result information 48z, keyword analysis result information 50z, and analysis result information 58z respectively from the voice authenticator 13z, the silence analyzer 14z, the keyword analyzer 16z, and the voice recognizer 10z, and a message synthesizer 22z for receiving a scenario message 55z from the scenario analyzer 21z and for outputting message synthesized voice data.

The voice authenticator 13z and the scenario analyzer 21z are respectively connected to an individual authentication data storage 35z (hereinafter, data bank itself stored in the storage 35z is referred to as individual authentication data 35z) and a scenario data storage 37z (hereinafter, data bank itself stored in the storage 37z is referred to as scenario data 37z).

The voice recognizer 10z includes an acoustic analyzer 21z for inputting the voice signal 40z to output the voice data 41z-43z (data 41z-43z are the same data), and a checkup processor 12z for receiving the voice data 41z to output the keyword information 45z and the analysis result information 58z.

The acoustic analyzer 11z is connected to an acoustic data storage 31z (hereinafter, data bank itself stored in the storage 31z is referred to as acoustic data 31z), and the checkup processor 12z is connected to a dictionary data storage 32z, an unnecessary word data storage 33z, and a keyword data storage 34z.

It is to be noted that hereinafter, data banks themselves stored in the storages 32z-34z are respectively referred to as dictionary data 32z, unnecessary word data 33z, and keyword data 34z.

In operation, the acoustic analyzer 11z performs an acoustic analysis including echo canceling to the voice signal 40z by referring to the acoustic data 31z to be converted into voice data, and outputs the voice data as the voice data 41z-43z.

The checkup processor 12z converts the voice data 41z into a voice text 59 (see FIG. 7 described later) by referring to the dictionary data 32z, and then extracts keywords and unnecessary words from the voice text 59 by referring to the unnecessary word data 33z and the keyword data 34z.

The silence analyzer 14z analyzes whether or not any silence is included in the voice data 43z. The keyword analyzer 16z analyzes the content of the keyword information 45z received from the checkup processor 12z. The voice authenticator 13z provides to the scenario analyzer 21z the individual identifying information 47z which identifies a user from the voice data 42z by referring to the individual authentication data 35z.

The scenario analyzer 21z selects a scenario message (hereinafter, sometimes simply referred to as scenario) from the scenario data 37z based on the analysis result information 58z, 48z, 50z of the checkup processor 12z, the silence analyzer 14z, and the keyword analyzer 16z, and provides the scenario message 55z to the message synthesizer 22z.

At this time, the scenario analyzer 21z can select a scenario corresponding to a specific user based on the individual identifying information 47z.

The message synthesizer 22z synthesizes message-synthesized voice data 56z based on the scenario message 55z. A message output portion 300 outputs the data 56z in the form of voice to the user.

In such a voice interaction apparatus 100z, a voice recognizer 10z of a voice input/output apparatus as disclosed in the Japanese Patent Application Laid-open No. 5-27790 measures a word speed from time intervals between words, a time required for a response, and uniformity of time intervals between words, and determines the kinds of words.

Also, the voice input apparatus has means for measuring frequencies of user's voice inputted, and for calculating their average to be compared with a criteria frequency.

Also, the voice input apparatus further has means for preliminarily storing data indicating tendencies of the past users, analyzed from voices, which form a reference for determining a user's type.

The voice input apparatus has means for determining the user's type by comparing the determination result data with the reference data, and means for outputting a response message corresponding to an identified user's type among a plurality of response messages for a single operation respectively corresponding to the determined user's type.

In operation, from the voice response of the user, the user's gender (determined from the frequency of the voice), and parameters such as fast talking, ordinary talking, and slow talking are extracted. From these parameters, the user's type (fluent, ordinary, stumbling) is determined. The response (brief, usual, more detailed) corresponding to the determined type is performed.

Namely, the voice interaction apparatus 100z provides navigation in accordance with the user's type. When prompting the user to perform a single operation, the navigation transmits a message in which the “phrase” of the fixed navigation depends on the user's type.

Also, in a voice response apparatus (voice interaction apparatus) disclosed in the Japanese Patent Application Laid-open No. 2001-331196, a learning degree of a user for the operation of this voice response apparatus is estimated from the voice content of the user, and the operation of the voice response apparatus is guided according to the learning degree estimated.

Also, the voice response apparatus provides a guidance indicating an operation procedure of the voice response apparatus according to the learning degree estimated, and guides the operation of the voice response apparatus.

Also, the voice response apparatus controls a timing for accepting the voice of the user according to the learning degree estimated.

Namely, e.g. “oh”, “let me see”, “please --”, and the like are extracted as unnecessary words uttered by a user, and the learning degree (unaccustomed/less accustomed/accustomed) is determined from the extracted words.

Depending on the determined result, the guidance corresponding to the learning degree of the user, i.e. the guidance corresponding to unaccustomed/less accustomed/accustomed respectively is transmitted to the user.

In such a prior art voice input/output apparatus (Japanese Patent Application Laid-open No. 5-27790), a message is transmitted corresponding to a user's type when the user is prompted to perform a single operation, and the navigation message of the scenario is varied.

On the other hand, in the voice response apparatus (Japanese Patent Application Laid-open No. 2001-331196), depending on the learning degree of the user for the voice response apparatus, the operation is guided, the guidance indicating the operation procedure is provided, and the timing for accepting the user's voice is controlled.

In such a voice interaction apparatus, causes of silence and vacillation of the user due to anything other than insufficient explanation are not analyzed. Therefore, messages from which the factors (no other choice or no alternatives, etc. but to do other operations due to insufficient information) of the silence and the vacillation are removed can not be transmitted, which leads to services difficult to be used for the user.

Namely, in summary, there have been issues (1)-(4) as follows:

(1) In the presence of obscurity for an inputting operation, it means insufficient supports (explanation of how to use) of the voice input apparatus side, so that a user can not easily understand;

(2) An incomplete interaction response content can not be accepted by the voice input apparatus;

(3) An erroneous input can not be promptly and easily corrected;

(4) Even when a user hesitates to determine his intension, information for helping the determination is not provided.

### SUMMARY OF THE INVENTION

It is accordingly an object of the present invention to provide a voice interaction apparatus for offering voice response services utilizing speech or voice and for offering response services corresponding to a user's response state (status). Specifically, interaction is performed corresponding to states where the user can not understand, where the user can not be accepted by the voice interaction apparatus due to an incomplete interaction response content, where the user can not correct erroneous input promptly and easily, and where the user hesitates to determine his intension.

In order to achieve the above-mentioned object, a voice interaction apparatus according to the present invention comprises: a voice recognizer for detecting an interaction response content indicating a psychology (psychology state) of a voice-inputting person at a time of a voice interaction; and an input state analyzer for analyzing the interaction response content and for classifying the psychology into predetermined input state information (claim 1).

FIG. 1 shows a principle of a voice interaction apparatus 100 of the present invention. This voice interaction apparatus 100 is provided with a voice recognizer 10 and an input state analyzer 18. The voice recognizer 10 detects, from an input voice, an interaction response content indicating a psychology of a voice-inputting person (user). The input state analyzer 18 analyzes the interaction response content to classify the psychology into input state information.

Thus, it becomes possible to offer services corresponding not to the prior art type of the voice-inputting person or learning degree of the voice-inputting person for the voice interaction apparatus but to the psychology (input state information) of the voice-inputting person, i.e. a response state.

Also, in the present invention according to the above-mentioned present invention, the interaction response content may comprise at least one of a keyword, an unnecessary word, an unknown word, and a silence (claim 2).

Namely, it becomes possible to analyze the psychology of the voice-inputting person based on a keyword expected to be responded from the voice-inputting person when the interaction voice is inputted, an unnecessary word unexpected to be responded, an unknown word which is neither the keyword nor the unnecessary word, and a silence state.

According to such an interaction response content, it becomes possible to realize interactions corresponding to the states where the user can not understand the interaction voice, where the user can not be accepted by the voice interaction apparatus due to an incomplete interaction response content, where the user can not correct erroneous input promptly and easily, and where the user hesitates to determine his intension.

It is to be noted that there is cited e.g. “hotel”, “sightseeing”, or the like as a keyword in selecting hotel guidance or sightseeing guidance, and it is regarded that this keyword indicates e.g. certainty (psychology) of a voice-inputting person. The examples of the unnecessary words indicating the psychology include “I'm not confident”, “I'm at a loss”, or the like indicating the psychology of the user himself/herself as it is, in addition to “Gee”, “I wonder”, “This is it”, or the like.

Also, in the present invention according to the above-mentioned present invention, the interaction response content may comprise at least one of starting positions of the keyword, the unnecessary word, the unknown word, and the silence (claim 3).

Thus, if at least one of starting positions of the keyword, the unnecessary word, the unknown word, and the silence in the interaction response content indicates a psychology, the psychology of the voice-inputting person can be classified into input state information.

Also, in the present invention according to the above-mentioned present invention, the input state information may comprise at least one of vacillation, puzzle, and anxiety (claim 4).

Thus, based on a digital divide psychology (input state information) such as “vacillation”, “puzzle”, and “anxiety” of the voice-inputting person, a scenario can be selected.

Examples of classifying the psychology of the voice-inputting person into predetermined input state information based on the interaction response content of the voice-inputting person will now be described.

(1) Example of Parameter Selection for Analyzing User Psychology

Users' reactions to inquiries of voice navigation from the voice interaction apparatus 100 are classified into the followings (11), (12), and (21)-(24).

In Case User Answers Keyword:

(11) The user feels certain about his/her answer content. Namely, the user “has answered confidently”.

(12) The user does not feel certain about his/her answer content. Namely, the user “has hastened to answer though the user is not confident”.

In Case User Does Not Answer Keyword:

(21) The content of navigation is unclear. Namely, a user can not understand “the content of the inquiry”.

(22) Although the content of the navigation is clear, the content of the inquiry is different from the content the user himself wants, or has no relation to the content the user wants to listen (perform). For example, the user “feels unexpected”.

(23) Although the content of the navigation is clear and what the user wants, the user is vacillating on his/her answer content. For example, the user “is vacillating on selecting a single from among a plurality of alternatives for his/her answer”.

(24) Although the content of the navigation is clear and what the user wants, the user is anxious about his/her answer content. Namely, the user “is anxious about whether or not the content the user is going to answer is correct”.

For the psychology (input state information), parameters such as “degree of puzzle P1”, “degree of vacillation P2”, and “degree of anxiety P3” are used. The definition of the parameters P1-P3 will now be described.

Degree of puzzle P1: This indicates that the user looks puzzled because the user can not understand the navigation, the navigation content is different from what the user wants, or the like.

Degree of vacillation P2: This indicates that the user could understand the content of the navigation, but the user is vacillating on his/her answer content to the inquiry.

Degree of anxiety P3: This indicates that the user could understand the content of the navigation, and has determined the answer content to the inquiry, but the user is still anxious about whether or not the content the user has selected is correct.

Hereinafter, the method of analyzing the user's psychology by using the above-mentioned three parameters will be described.

Analysis Method in Case User Answers Keyword:

This analysis method is as follows:

(11) The user feels certain about an answer content: This indicates that the user can understand the content of the navigation, and indicates the following cases where

the content of the navigation is what the user wants:

“degree of puzzle” is low;

he/she is not vacillating on his/her answer content:

“degree of vacillation” is low;

he/she is not anxious about his/her answer content:

“degree of anxiety” is low.

(12) The user feels uncertain about his/her answer content: This indicates any case where

he/she can not understand the content of the navigation,

the content of the navigation is different from what the user wants:

“degree of puzzle” is high;

he/she is vacillating on his/her answer content:

“degree of vacillation” is high;

he/she is anxious about his/her answer content:

“degree of anxiety” is high.

FIG. 2 shows a determination example (1) for determining the “degree of puzzle”, the “degree of vacillation”, and the “degree of anxiety” corresponding to the above-mentioned psychologies (11) and (12). Based on this determination example (1), the psychologies can be analyzed or classified into input state information.

It is to be noted that for criteria such as “degree of puzzle”, “degree of vacillation”, and “degree of anxiety” as parameters, the most suitable one is selected depending on the content of the navigation. Specific values will be later described in the embodiments.

Also, keywords indicating “degree of vacillation”, “degree of puzzle”, and “degree of anxiety”, and reference values mentioned in the embodiments are exemplified. Suitable keywords and reference values are set in a system which applies these values.

Analysis Method in Case User Does Not Answer Keyword:

Hereinafter, an analysis method in case a user does not answer a keyword will be described.

(21) The content of the navigation is not clear: This indicates the case where

the user can not understand the content of the navigation.

(22) The content of the navigation is clear but is not what the user wants, which indicates the cases where

the user can understand the content of the navigation;

the content of the navigation is not what the user wants:

“degree of puzzle” is high.

(23) The content of the navigation is clear and what the user wants, but the user is vacillating on his/her answer content. This indicates the cases where

the user can understand the content of the navigation;

the content of the navigation is what the user wants:

“degree of puzzle” is low;

the user is vacillating on the content of his/her answer:

“degree of vacillation” is high.

(24) The content of the navigation is clear and what the user wants, but the user is anxious about his/her answer content. This indicates the cases where

the user can understand the content of the navigation;

the content of the navigation is what the user wants:

“degree of puzzle” is low;

the answer content is selected:

“degree of vacillation” is low;

the user is anxious about his/her answer content selected:

“degree of anxiety” is high.

FIG. 3 shows a determination example (2) for determining “degree of puzzle”, “degree of vacillation”, and “degree of anxiety” corresponding to the psychologies (21)-(24).

It is to be noted that for criteria parameters, “degree of puzzle”, “degree of vacillation”, and “degree of anxiety”, the most suitable reference is selected according to the content of the navigation.

[2] Usage Example of User Psychology Analysis Result

Based on the analysis result of the above-mentioned [1], the processings corresponding to respective results are performed.

(1) In Case User Answers Keyword

(11) The user feels certain about his/her answer content: The subsequent scenario is transmitted to the user.

(12) The user feels uncertain about his/her answer content: The answer content is confirmed.

(2) In Case User Does Not Answer Keyword

(21) The content of the navigation is not clear: The user is inquired again with detailed information added.

(22) The content of the navigation is clear, but it is not what the user wants: Transition to another scenario is prompted.

(23) The content of the navigation is clear and what the user wants, but the user is vacillating on his/her answer content: The user is inquired again with detailed information added.

(24) The content of the navigation is clear and what the user wants, but the user is anxious about his/her answer content: The user is inquired again with detailed information added.

Also, the present invention according to the above-mentioned present invention may further comprise: a scenario database for storing a scenario corresponding to the input state information; and a scenario analyzer for selecting a scenario for a voice-inputting person based on the input state information (claim 5).

Namely, in FIG. 1, the voice interaction apparatus 10 is provided with a scenario data (base) 37 and a scenario analyzer 21. The scenario data 37 stores a scenario corresponding to the input state information (psychology of voice-inputting person). The scenario analyzer 21 selects a scenario based on input state information 54 received from the input state analyzer 18.

Thus, it becomes possible to select a scenario corresponding to the psychology of the voice-inputting person. It is to be noted that the selection of the scenario can be made by analyzing the psychology of the voice-inputting person for each interaction.

Also, in the present invention according to the above-mentioned present invention, the voice recognizer may have an unnecessary word database associating an unnecessary word indicating the psychology with unnecessary word analysis result information obtained by digitizing the psychology, and an unnecessary word analyzer for converting the unnecessary word into the unnecessary word analysis result information based on the unnecessary word database (claim 6).

In FIG. 1, the voice recognizer 10 is provided with an unnecessary word data (base) 33 and an unnecessary word analyzer 15 (shown outside the voice recognizer 10 in FIG. 1 for convenience sake). The unnecessary word data 33 associates an unnecessary word indicating the psychology with unnecessary word analysis result information obtained by digitizing the psychology. The unnecessary word analyzer 15 converts the unnecessary word into the unnecessary word analysis result information based on the unnecessary word data 33.

Thus, it becomes possible to process the psychology of the voice-inputting person by digitizing the same.

Also, in the present invention according to the above-mentioned present invention, the input state analyzer may classify the psychology of the voice-inputting person into the input state information based on one or more unnecessary word analysis result information (claim 7).

Namely, in FIG. 1, a response voice of a voice-inputting person includes one or more unnecessary words indicating the psychology of the voice-inputting person. Accordingly, the number of unnecessary word analysis result information is single or plural, so that the input state analyzer 18 outputs the input state information 54 classified into the psychology of the voice-inputting person based on one or more unnecessary word analysis result information 49.

Also, in the present invention according to the above-mentioned present invention, the voice recognizer may further have a silence analyzer for detecting a silence time included in the interaction response content, and the input state analyzer may correct the input state information based on the silence time (claim 8).

Namely, the voice recognizer 10 is provided with a silence analyzer 14 (shown outside the voice recognizer 10 in FIG. 1 for the convenience sake), which detects a silence (e.g. silence duration, silence starting position) included in the voice. The input state analyzer 18 can correct the input state information based on e.g. a silence time before a keyword or a silence starting position.

Also, in the present invention according to the above-mentioned present invention, the voice recognizer may further have a keyword analyzer for analyzing an intensity of a keyword included in the interaction response content, and the input state analyzer may correct the input state information based on the intensity (claim 9).

Namely, as shown in FIG. 1, the voice recognizer 10 is provided with a keyword analyzer 16 (shown outside the voice recognizer 10 in FIG. 1 for convenience sake). This keyword analyzer 16 analyzes an intensity of a keyword included in the interaction response content. The input state analyzer 18 can correct the input state information based on the intensity of the keyword.

Also, in the present invention according to the above-mentioned present invention, the voice recognizer may further have an unknown word analyzer for detecting a ratio of unknown words included in the interaction response content to the interaction response content, and the input state analyzer may correct the input state information based on the ratio (claim 10).

Namely, as shown in FIG. 1, the voice recognizer 10 is provided with an unknown word analyzer 17 (shown outside the voice recognizer 10 in FIG. 1 for convenience sake), which detects a ratio of unknown words included in the interaction response content (voice) with respect to the voice. The input state analyzer 18 can correct the input state information by this ratio.

Also, the present invention according to the above-mentioned present invention may further comprise an overall-user input state history processor for accumulating the input state information in an input state history database, and the input state analyzer may correct the input state information based on the input state history database (claim 11).

Namely, as shown in FIG. 1, the voice interaction apparatus 100 is provided with an overall-user input state history processor 19 and an input state history data (base) 36. This processor 19 accumulates the input state information 54 received from the input state analyzer 18 in the input state history data 36.

The input state analyzer 18 corrects the input state information by comparing e.g. the average of the input state history data 36 with the input state information.

Thus, it becomes possible to correct the present input state information based on a statistical value of the past input state information.

Also, the present invention according to the above-mentioned present invention may further comprise: a voice authenticator for identifying the voice-inputting person based on the voice of the voice-inputting person; and an individual input state history processor for accumulating the input state information per voice-inputting person in an input state history database; and the input state analyzer may correct the input state information based on the input state history database (claim 12).

Namely, as shown in FIG. 1, the voice interaction apparatus 100 is provided with a voice authenticator 13, an individual input state history processor 20, and an input state history data (base) 36. The voice authenticator 13 identifies a voice-inputting person based on the voice of same. The individual input state history processor 20 accumulates the input state information in the input state history data 36 per voice-inputting person. The input state analyzer 18 corrects the input state information based on the input state history data 36 per voice-inputting person.

Thus, it becomes possible to correct the present input state information based on the statistical value of the past individual input state information.

Also, in the present invention according to the above-mentioned present invention, the scenario analyzer may further select the scenario based on a keyword included in the interaction response content (claim 13).

Namely, in FIG. 1, the scenario analyzer 21 can select a scenario based on the input state information and a keyword.

Furthermore, in the present invention according to the above-mentioned present invention, the scenario may include at least one of a scenario for proceeding to a situation subsequent to a present scenario, a scenario for confirming whether or not the present scenario is acceptable, a scenario for transitioning to a scenario different from the present scenario, a scenario for describing in detail the present scenario, and a scenario for connecting to an operator (claim 14).

Namely, the scenario analyzer 21 can select, as a subsequent scenario, based on the input state information, at least one of a scenario for proceeding to a situation subsequent to a present scenario, a scenario for confirming whether or not the present scenario is acceptable, a scenario for transitioning to a scenario different from the present scenario, a scenario for describing in detail the present scenario, and a scenario for connecting to an operator.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of a voice interaction apparatus according to the present invention;

FIG. 2 is a diagram showing a determination example (1) of a psychology in a voice interaction apparatus according to the present invention;

FIG. 3 is a diagram showing a determination example (2) of a psychology in a voice interaction apparatus according to the present invention;

FIG. 4 is a flow chart in an embodiment (1) of a voice interaction apparatus according to the present invention;

FIG. 5 is a diagram showing an operation example of a voice input portion in an embodiment (1) of a voice interaction apparatus according to the present invention;

FIG. 6 is a diagram showing an operation example of an acoustic analyzer in an embodiment (1) of a voice interaction apparatus according to the present invention;

FIG. 7 is a diagram showing an operation example of a checkup processor in an embodiment (1) of a voice interaction apparatus according to the present invention;

FIG. 8 is a diagram showing an operation example of silence analyzer in an embodiment (1) of a voice interaction apparatus according to the present invention;

FIG. 9 is a diagram showing an operation example of an unnecessary word analyzer in an embodiment (1) of a voice interaction apparatus according to the present invention;

FIG. 10 is a diagram showing an operation example of a keyword analyzer in an embodiment (1) of a voice interaction apparatus according to the present invention;

FIG. 11 is a diagram showing an operation example of an unknown word analyzer in an embodiment (1) of a voice interaction apparatus according to the present invention;

FIG. 12 is a diagram showing an operation example of an input state analyzer in an embodiment (1) of a voice interaction apparatus according to the present invention;

FIG. 13 is a diagram showing an example of an analysis procedure in an input state analyzer in an embodiment (1) of a voice interaction apparatus according to the present invention;

FIG. 14 is a diagram showing an operation example of an overall-user input state history processor in an embodiment (1) of a voice interaction apparatus according to the present invention;

FIG. 15 is a diagram showing an operation example of a scenario analyzer in an embodiment (1) of a voice interaction apparatus according to the present invention;

FIGS. 16A and 16B are diagrams showing examples of a specified value set in a scenario analyzer in an embodiment (1) of a voice interaction apparatus according to the present invention;

FIG. 17 is a transition diagram showing an example of a situation transition set in a scenario analyzer in an embodiment (1) of a voice interaction apparatus according to the present invention;

FIG. 18 is a diagram showing an operation example of a message synthesizer in an embodiment (1) of a voice interaction apparatus according to the present invention;

FIG. 19 is a diagram showing an operation example of a message output portion in an embodiment (1) of a voice interaction apparatus according to the present invention;

FIG. 20 is a flow chart in an embodiment (2) of a voice interaction apparatus according to the present invention;

FIG. 21 is a diagram showing an operation example of an acoustic analyzer in an embodiment (2) of a voice interaction apparatus according to the present invention;

FIG. 22 is a diagram showing an operation example of a voice authenticator in an embodiment (2) of a voice interaction apparatus according to the present invention;

FIG. 23 is a diagram showing an operation example of an input state analyzer in an embodiment (2) of a voice interaction apparatus according to the present invention;

FIG. 24 is a diagram showing an example of an analysis procedure of an input state analyzer in an embodiment (2) of a voice interaction apparatus according to the present invention;

FIG. 25 is a diagram showing an operation example of an individual input state history processor in an embodiment (2) of a voice interaction apparatus according to the present invention; and

FIG. 26 is a block diagram showing an arrangement of a prior art voice interaction apparatus.

### DESCRIPTION OF THE EMBODIMENTS

Embodiment (1)

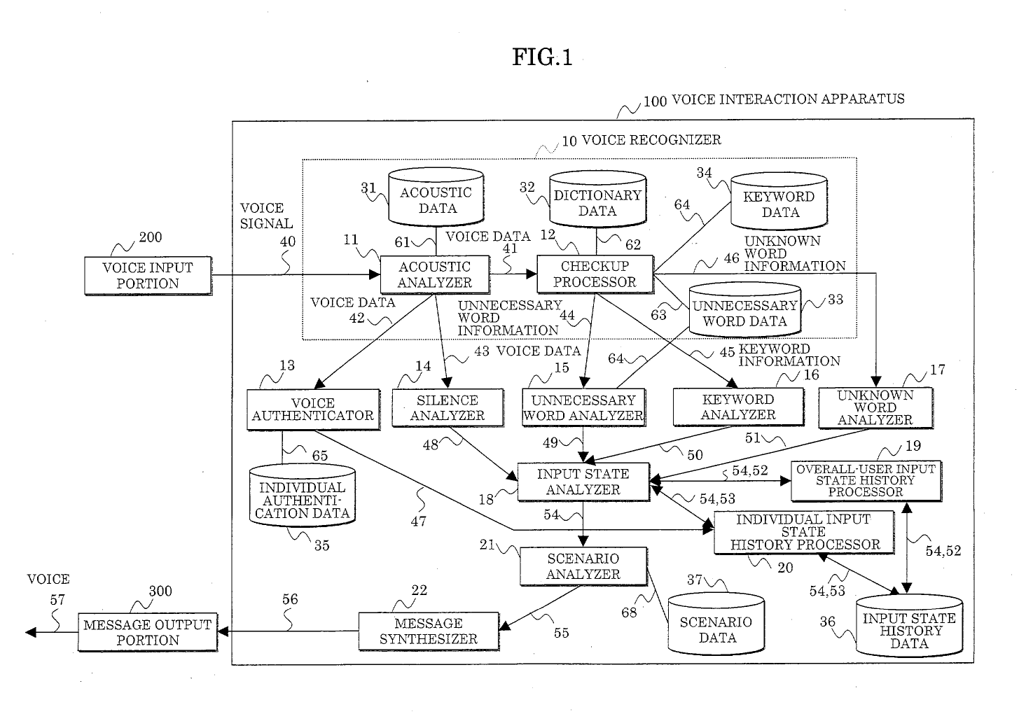

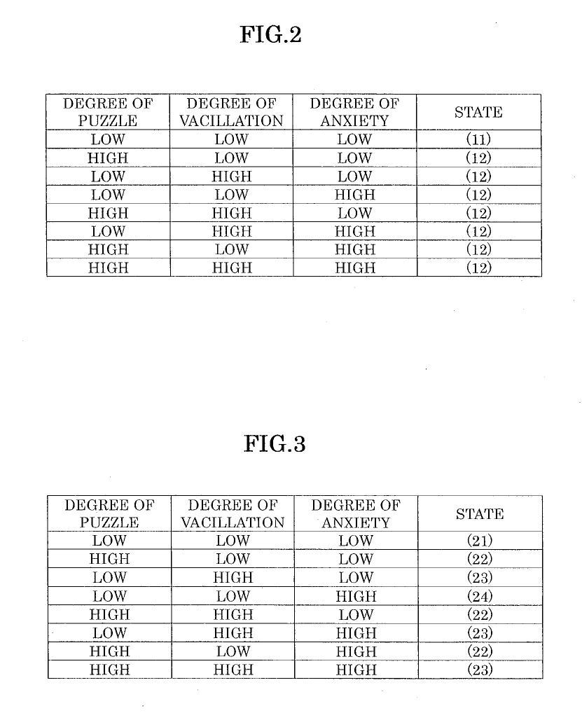

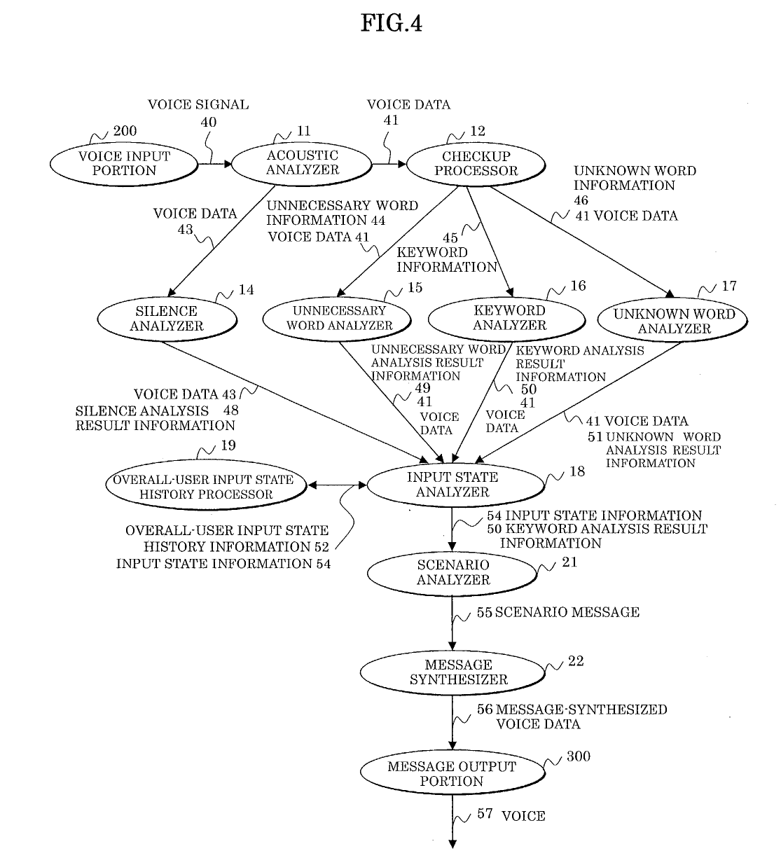

FIG. 4 shows an embodiment (1) of an operation of the voice interaction apparatus 100 according to the present invention shown in FIG. 1. The arrangement of the voice interaction apparatus 100 in this embodiment (1) precludes the voice authenticator 13, the individual authentication data 35, and the individual input state history processor 20 in the voice interaction apparatus 100 shown in FIG. 1.

It is to be noted that the acoustic data 31, the dictionary data 32, the unnecessary word data 33, the keyword data 34, the individual authentication data 35, and the input state history data 36 shown in FIG. 1 are supposed to indicate data banks of the concerned data and storages for storing the concerned data.

Also, in the embodiment (1) of FIG. 4, a flow in which the acoustic analyzer 11 accesses the acoustic data 31, a flow in which the checkup processor 12 accesses the dictionary data 32, the unnecessary word data 33, and the keyword data 34, and a flow in which the overall-user input state history processor 19 accesses the input state history data 36 are omitted for simplifying the diagram.

Together with this omission, the acoustic data 31, the dictionary data 32, the unnecessary word data 33, the keyword data 34, and the input state history data 36 are also omitted for simplifying the diagram.

The schematic operation of the voice interaction apparatus 100 in the embodiment (1) will be first described.

The acoustic analyzer 11 performs an acoustic analysis to the voice signal 40 inputted from the voice input portion 200 to prepare the voice data 41 and 43. It is to be noted that the voice data 41 and 43 are the same voice data.

The silence analyzer 14 analyzes an arising position of a silence and a silence time in the voice data 43. The checkup processor 12 converts the voice data 41 into a voice text by referring to the dictionary data 32, and then extracts keywords, unnecessary words, and unknown words respectively from the voice text by referring to the keyword data 34 and the unnecessary word data 33.

The unnecessary word analyzer 15 digitizes degrees of “vacillation”, “puzzle”, and “anxiety” of a user. The keyword analyzer 16 digitizes “intensity of a keyword”, and the unknown word analyzer 17 analyzes “amount of unknown words”.

The input state analyzer 18 performs a comprehensive analysis based on analysis result information 48, 49, 50, 51 respectively obtained from the silence analyzer 14, the unnecessary word analyzer 15, the keyword analyzer 16, and the unknown word analyzer 17, and the overall-user input state history information 52 obtained from the input state history data 36 through the overall-user input state history processor 19, and then determines the input state information (psychology) 54 of the user.

Also, the overall-user input state history processor 19 accumulates the determined input state information 54 in the input state history data 36.

The scenario analyzer 21 selects the most suitable scenario for the user from among the scenario data 37 based on the determined input state information 54. The message synthesizer 22 synthesizes the message of the selected scenario, and the message output portion 300 outputs a voice-synthesized message to the user as a voice.

Hereinafter, more specific operation per functional portion of the voice interaction apparatus 100 in the embodiment (1) will be described referring to FIGS. 5-19.

It is to be noted that in this description, “□□Let me see. □□Reservation, I wonder. *Δ◯◯*Δ” is supposed to be used as an example of the voice signal 40 inputted to the voice interaction apparatus 100. It is herein supposed that “□” is a silence, “Let me see” and “I wonder” are unnecessary words, “*□◯◯*Δ” are unknown words, and “reservation” is a keyword.

Voice Input Portion 200 (see FIG. 5)

Step S100: The voice input portion 200 accepts a user's voice “ΔΔLet me see. ΔΔReservation, I wonder. *Δ◯◯*Δ”, and assigns this voice to the acoustic analyzer 11 as the voice signal 40.

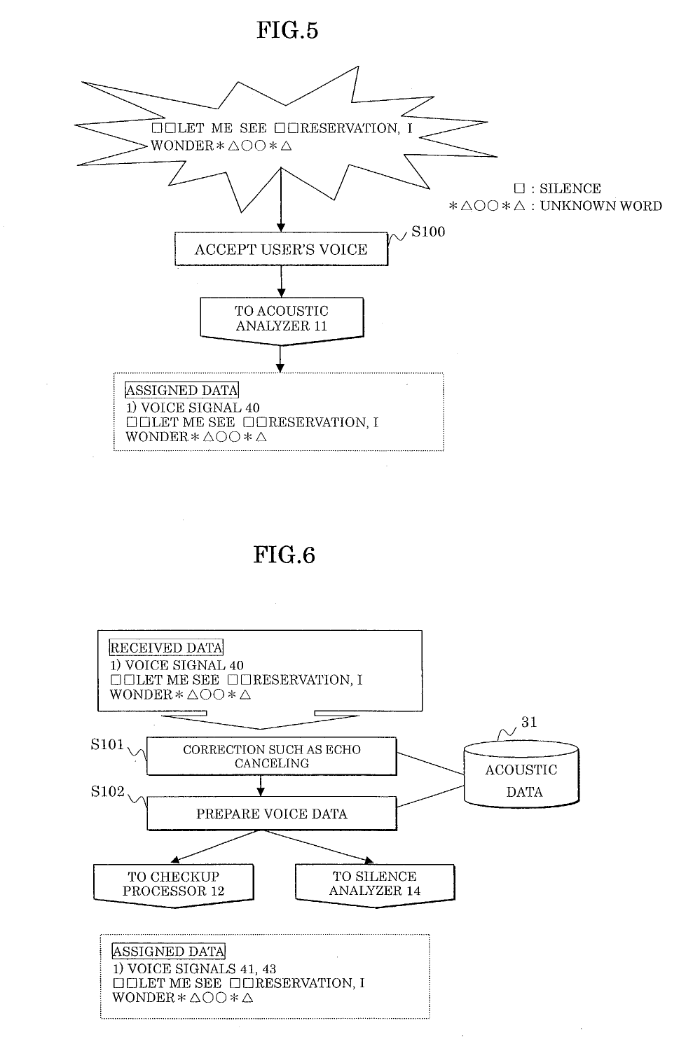

Acoustic Analyzer 11 (see FIG. 6)

Steps S101 and S102: The acoustic analyzer 11 performs processing such as echo canceling to the received voice signal 40 by referring to the acoustic data 31, prepares the voice data corresponding to the voice signal 40, and assigns the voice data to the checkup processor 12 and the silence analyzer 14 as the voice data 41 and 43, respectively.

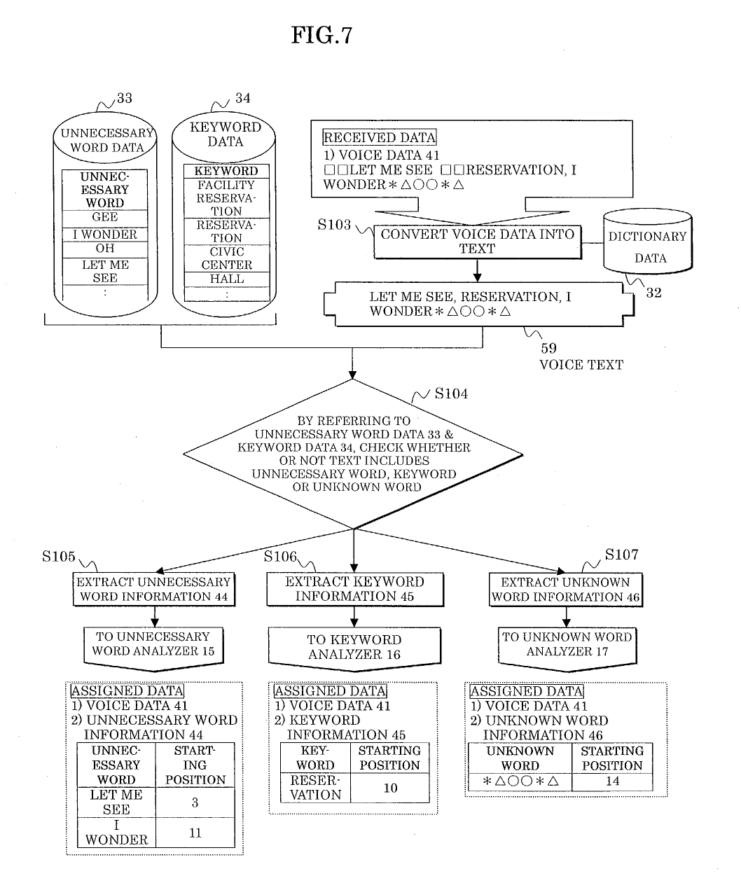

The Checkup Processor 12 (see FIG. 7)

Step S103: The checkup processor 12 converts the voice data 41 into the voice text 59 by referring to the dictionary data 32.

Steps S104-S107: The checkup processor 12 extracts “keywords”, “unnecessary words”, and “unknown words (words which are neither unnecessary words nor keywords)” from the voice text 59 by referring to the keyword data 34 and the unnecessary word data 33, and detects a starting position on the time-axis of the words in the voice data 41.

The checkup processor 12 prepares unnecessary word information 44, keyword information 45, and unknown word information 46 respectively associating an “unnecessary word” with its “starting position”, a “keyword” with its “starting position”, and an “unknown word” with its “starting position”, and then assigns the unnecessary word information 44, the keyword information 45, and the unknown word information 46 together with the voice data 41 to the unnecessary word analyzer 15, the keyword analyzer 16, and the unknown word analyzer 17, respectively.

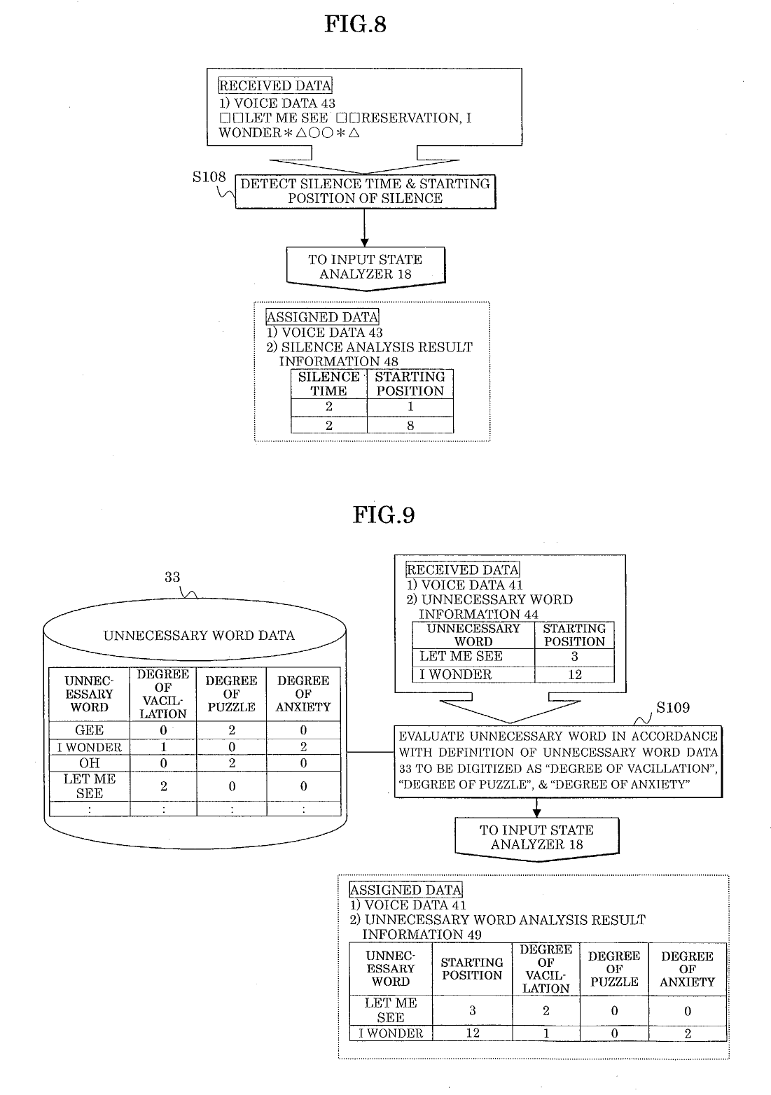

Silence Analyzer 14 (see FIG. 8)

Step S108: The silence analyzer 14 detects a “silence time” and the “starting position” of the silence in the voice data 43, prepares the silence analysis result information 48 in which these “silence time” and “starting position” are combined, and assigns this information 48 together with the voice data 43 to the input state analyzer 18.

Unnecessary Word Analyzer 15 (see FIG. 9)

Step S109: The unnecessary word analyzer 15 analyzes the degrees of the “vacillation”, the “puzzle”, and the “anxiety” of the unnecessary words such as “Let me see” and “I wonder” by referring to the unnecessary word data 33, and assigns the unnecessary word analysis result information 49 obtained by digitizing the user's “degree of vacillation”, “degree of puzzle”, and “degree of anxiety” together with the voice data 41 to the input state analyzer 18.

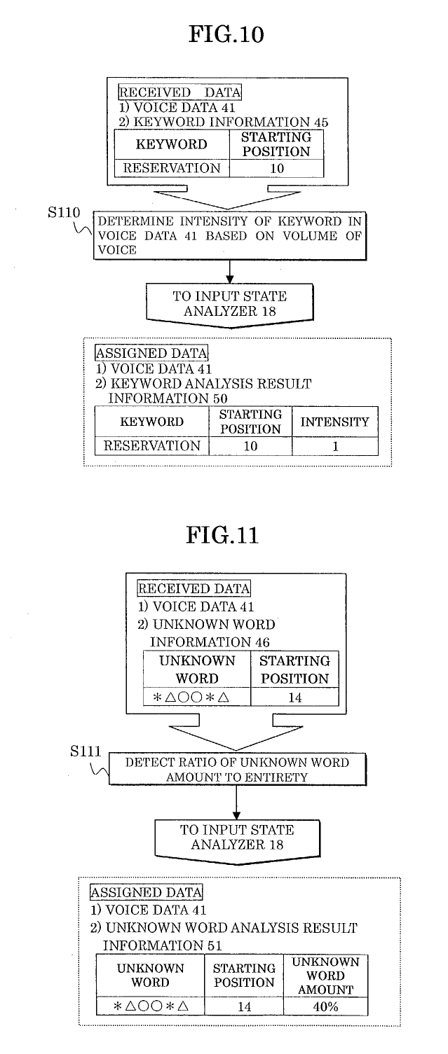

Keyword Analyzer 16 (see FIG. 10)

Step S110: The keyword analyzer 16 extracts the intensity (accent) of a keyword based on the keyword information 45 and the voice data 41, and assigns the keyword analysis result information 50 in which “keyword”, “starting position” and “intensity” are combined, together with the voice data 41 to the input state analyzer 18.

An “intensity” in this case indicates a relative intensity (amplitude) of the voice in a keyword portion on the voice data.

Unknown Word Analyzer 17 (see FIG. 11)

Step S111: The unknown word analyzer 17 detects “unknown word amount”, i.e. the ratio of the unknown words in the whole voice data based on the voice data 41 and the unknown word information 46, and then assigns the unknown word analysis result information 51 in which “unknown word”, “starting position”, and “unknown word amount” are combined, together with the voice data 41 to the input state analyzer 18.

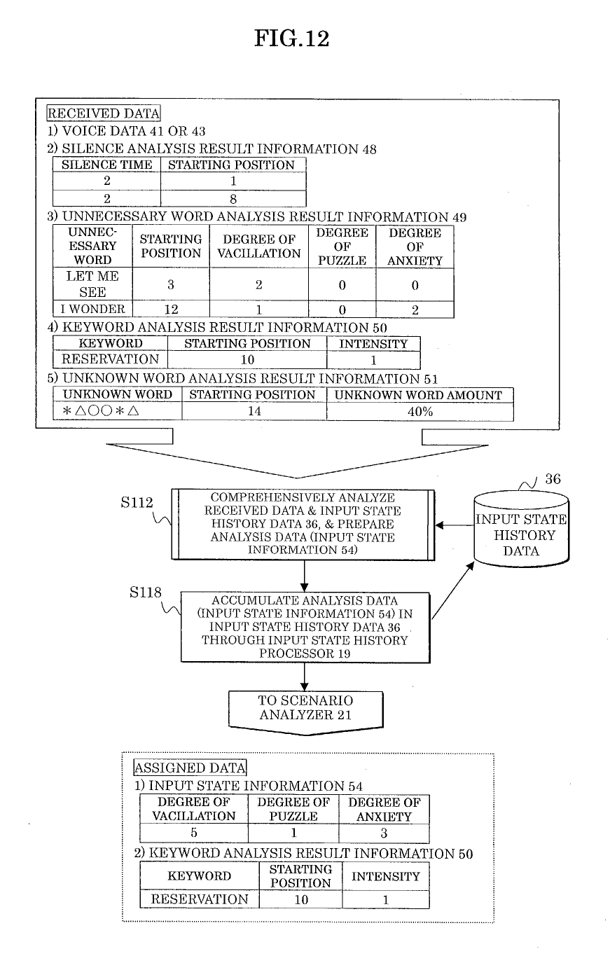

Input State Analyzer 18 (see FIG. 12)

Step S112: The input state analyzer 18 comprehensively analyzes the user's “vacillation”, “puzzle”, and “anxiety” digitized, based on the voice data 41 or 43 received from the analyzers 14-17, the silence analysis result information 48, the unnecessary word analysis result information 49, the keyword analysis result information 50, and the unknown word analysis result information 51.

Upon this analysis, the input state analyzer 18 performs correction using the input state history data 36.

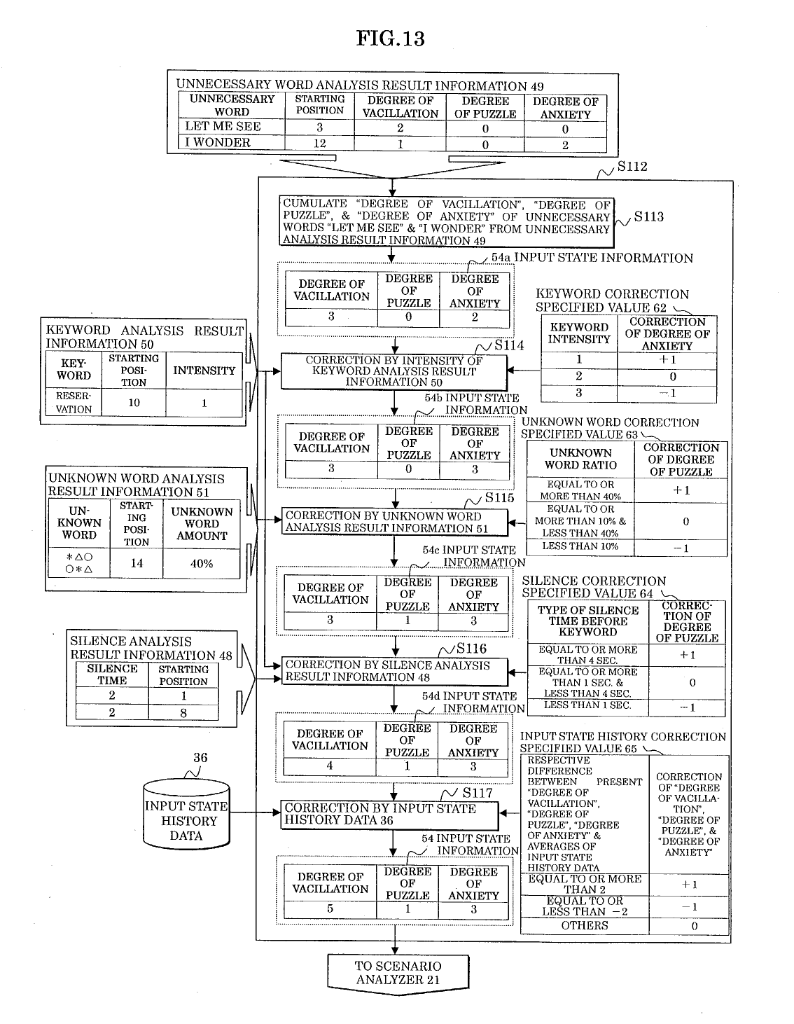

FIG. 13 shows a more detailed analysis procedure (steps S113-S117) of the input state analyzer 18 at the above-mentioned step S112. This analysis procedure will now be described.

Step S113: The input state analyzer 18 prepares the input state information 54 composed of “degree of vacillation”, “degree of puzzle”, and “degree of anxiety”, where each of the elements of the unnecessary word analysis result information 49, i.e. “degree of vacillation”, “degree of puzzle”, and “degree of anxiety” are cumulated.

Namely, the input state analyzer 18 prepares input state information 54a=(“degree of vacillation”=3, “degree of puzzle”=0, “degree of anxiety”=2) where the elements of the analysis result information 49 of the unnecessary word such as “Let me see” (“degree of vacillation”=2, “degree of puzzle”=0, “degree of anxiety”=0) and the elements of the unnecessary word such as “I wonder” (“degree of vacillation”=1, “degree of puzzle”=0, “degree of anxiety”=2) are cumulated per element.

Step S114: The input state analyzer 18 corrects the input state information 54a based on the keyword analysis result information 50 and a keyword correction specified value 62.

When the keyword portion is pronounced intensively (supposing “intensity”=“3”), the keyword correction specified value 62 is prescribed to determine that the “degree of anxiety” is small and to correct the “degree of anxiety” by “−1”. When the keyword portion is pronounced weakly (supposing “intensity”=“1”), the keyword correction specified value 62 is prescribed to determine that the “degree of anxiety” is large and to correct the “degree of anxiety” by “+1”. When the keyword portion is pronounced ordinarily (supposing “intensity”=“2”), the keyword correction specified value 62 is prescribed not to correct the “degree of anxiety”.

The input state analyzer 18 corrects the input state information 54a (supposing “degree of vacillation”=3, “degree of puzzle”=0, “degree of anxiety”=2) to input state information 54b (supposing “degree of vacillation”=3, “degree of puzzle”=0, “degree of anxiety”=3) based on the keyword analysis result information 50.

Step S115: The input state analyzer 18 corrects the input state information 54b based on the unknown word analysis result information 51 and an unknown word correction specified value 63.

When the “unknown word amount”=equal to or more than 40% for example, the unknown word correction specified value 63 is prescribed to determine that the “degree of puzzle” is large and to correct the “degree of puzzle” by “+1”. When the “unknown word amount”=less than 10%, the unknown word correction specified value 63 is prescribed to determine that the “degree of puzzle” is small and to correct the “degree of puzzle” by “−1”. When the “unknown word amount”=equal to or more than 10% and less than 40%, the unknown word correction specified value 63 is prescribed to determine that the “degree of puzzle” is ordinary and not to correct the “degree of puzzle”.

Since the “unknown word amount”=40% in the unknown word analysis result information 51, the input state analyzer 18 corrects the input state information 54b (supposing “degree of vacillation”=3, “degree of puzzle”=0, “degree of anxiety”=3) to input state information 54c (supposing “degree of vacillation”=3, “degree of puzzle”=1, “degree of anxiety”=3).

Step S116: The input state analyzer 18 corrects the input state information 54c based on the keyword analysis result information 50, the silence analysis result information 48, and a silence correction specified value 64. It is regarded that a silence time before a keyword indicates a psychology of vacillation, and the “degree of vacillation” is corrected.

When the “silence time” before the keyword=equal to or more than 4 sec. for example, the silence correction specified value 64 is prescribed to determine that the “degree of vacillation” is large and to correct the “degree of vacillation” by “+1”. When the “silence time” before the keyword=less than 1 sec., the silence correction specified value 64 is prescribed to determine that the “degree of vacillation” is small and to correct the “degree of vacillation” by “−1”. When the “silence time” before the keyword=equal to or more than 1 sec. and less than 4 sec., the silence correction specified value 64 is prescribed to determine that the “degree of vacillation” is ordinary and not to correct the “degree of vacillation”.

Since the silence time=4 sec. (=2 sec. +2 sec.) before the keyword=“reservation” (starting position=10 sec.) by referring to the keyword analysis result information 50 and the silence analysis result information 48, the input state analyzer 18 corrects the input state information 54c (supposing “degree of vacillation”=3, “degree of puzzle”=1, “degree of anxiety”=3) to input state information 54d (supposing “degree of vacillation”=4, “degree of puzzle”=1, “degree of anxiety”=3).

Step S117: The input state analyzer 18 corrects the input state information 54d based on the input state history data 36 and an input state history correction specified value 65.

This correction is performed by comparing averages of “degree of vacillation”, “degree of puzzle”, and “degree of anxiety” accumulated in the overall-user input state history data 36 with the specified value 65, thereby reflecting the characteristic of general users.

When the differences between the present values of “degree of vacillation”, “degree of puzzle”, “degree of anxiety” and the averages of the overall-user input state history data 36 are “equal to or more than 2”, “equal to or less than −2”, and “others”, the specified value 64 is prescribed to correct the present values by “+1”, “−1”, and “0” respectively.

The input state analyzer 18 calculates averages (e.g. “degree of vacillation”=2, “degree of puzzle”=1, “degree of anxiety”=2) of “degree of vacillation”, “degree of puzzle”, and “degree of anxiety” based on the input state history data 36, obtains the differences (“degree of vacillation”=2, “degree of puzzle”=0, “degree of anxiety”=1) obtained by subtracting the averages from the input state information 54d (“degree of vacillation”=4, “degree of puzzle”=1, “degree of anxiety”=3), and corrects the input state information 54d (“degree of vacillation”=4, “degree of puzzle”=1, “degree of anxiety”=3) to the input state information 54 (“degree of vacillation”=5, “degree of puzzle”=1, “degree of anxiety”=3).

By the above-mentioned steps S113-S117, the input state analyzer 18 analyzes the received data 48-51, and 36 to complete the preparation of the input state information 54.

It is to be noted that while in the above-mentioned analysis procedure, the input state information is first prepared based on the unnecessary word indicating the psychology of the voice-inputting person, and then this input state information is corrected by the analysis result information of the keyword, the unknown word, the silence state, or the like, the input state information 54 may be obtained by analyzing the psychology of the voice-inputting person based on at least one of the keyword, the unnecessary word, the unknown word, and the silence state.

Step S118: In FIG. 12, the input state analyzer 18 accumulates the input state information 54 in the input state history data 36 through the overall-user input state history processor 19. Furthermore, the input state analyzer 18 assigns the input state information 54 and the keyword analysis result information 50 to the scenario analyzer 21.

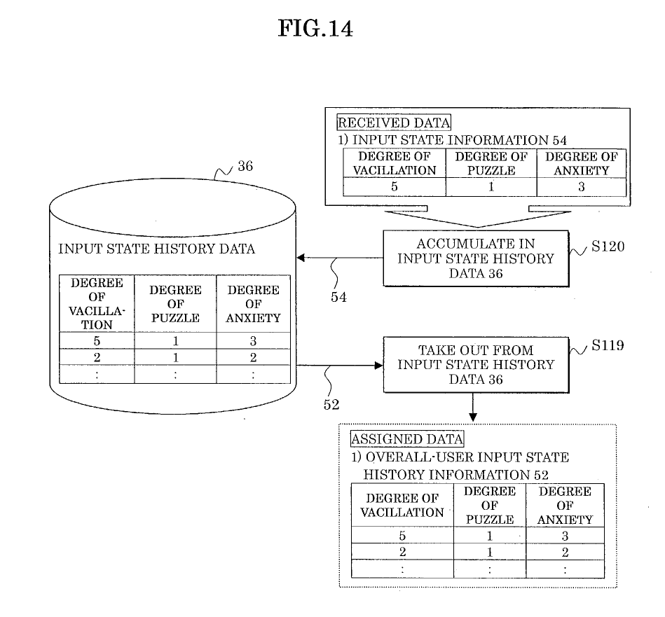

Overall-User Input State History Processor 19 (see FIG. 14)

The above-mentioned step S112 indicates the operation in which the input state history processor 19 provides the input state history data 36 to the input state analyzer 18. The above-mentioned step S118 indicates the operation in which the input state history processor 19 accumulates the input state information 54 received from the input state analyzer 18 in the input state history data 36.

Step S119: The processor 19 takes out the overall-user input state history information 52 from the input state history data 36 to be assigned to the input state analyzer 18.

Step S120: The processor 19 accumulates the input state information 54 received from the input state analyzer 18 in the input state history data 36.

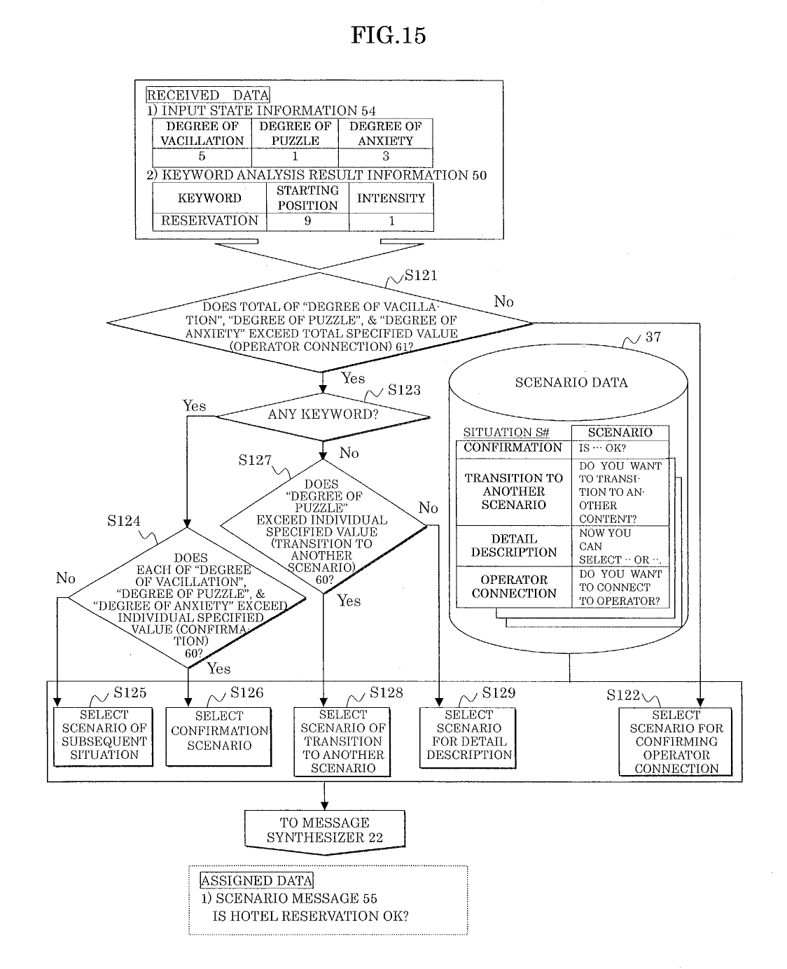

Scenario Analyzer 21 (see FIG. 15)

The schematic operation of the scenario analyzer 21 is to select a scenario message (message transmitted to a user) 55 for the interaction with the user based on the input state information 54 received from the input state analyzer 18 and the keyword analysis result information 50.

More specific operation of the scenario analyzer 21 will be described later referring to FIG. 15.

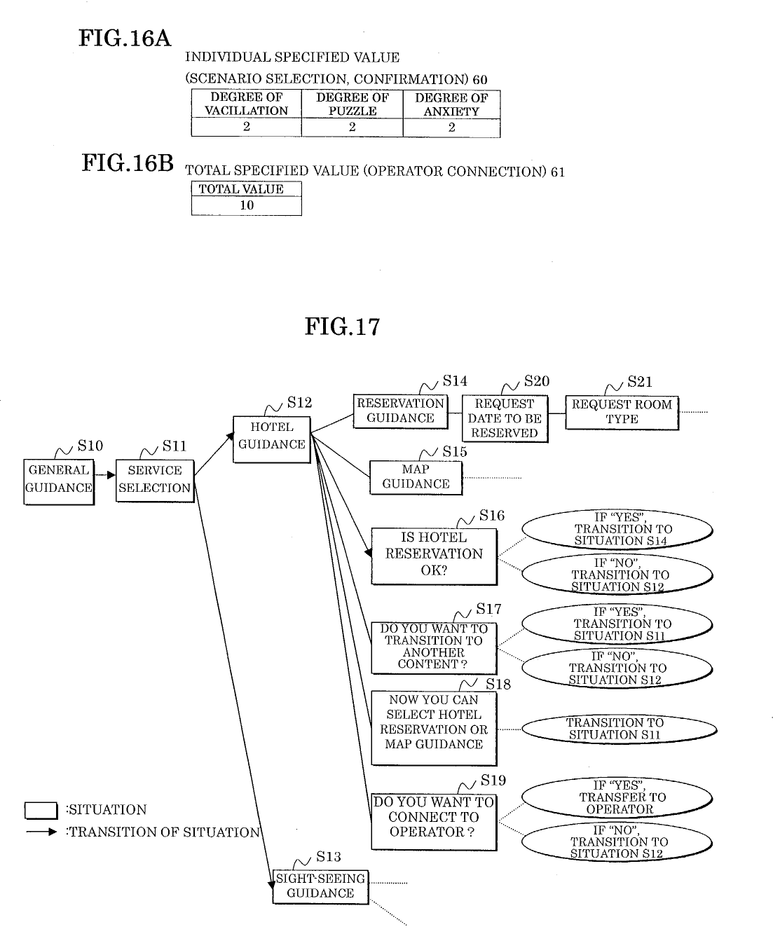

FIGS. 16A and 16B show examples of the specified values preliminarily held by the scenario analyzer 21. By comparing these specified values with the input state information 54, the scenario analyzer 21 selects a scenario.

FIG. 16A shows an individual specified value 60, that is a specified value respectively set for “degree of vacillation”, “degree of puzzle”, and “degree of anxiety” included in the input state information 54. It is set in FIG. 16A that “degree of vacillation”=2, “degree of puzzle”=2, and “degree of anxiety”=2.

FIG. 16B shows a total specified value 61, that is a specified value prescribed for the total value of “degree of vacillation”, “degree of puzzle”, and “degree of anxiety”. In FIG. 16B, “total specified value 61” =10 is set. For example, in case “degree of vacillation”=5, “degree of puzzle”=3, and “degree of anxiety”=4 of the input state information 54 (see FIG. 12), the total value of these values=12, which exceeds the “total specified value 61”.

FIG. 17 shows a situation selected by the scenario analyzer 21 and its transition state. The situation indicates the position (namely, how far the interaction is proceeding) of the interaction between the user and the voice interaction apparatus 100, and a scenario message is set for each situation.

The scenario data 37 shown in FIG. 15 indicates examples of the scenario messages set for each situation. The scenario messages are composed of a confirmation scenario, a scenario for transition to another scenario, a detailed description scenario, and an operator connection scenario.

For the confirmation scenario message, “Is - - O.K.?” is defined. For the scenario message for inquiring the transition to another scenario, “Do you want to transition to another content?” is defined. For the detail description scenario message, “Now, you can select - or -” is defined. For the operator connection scenario, “Do you want to connect to operator?” is defined.

According to the user's voice (more specifically, input state information 54 determined based on the user's voice) which has responded to these scenario messages, a situation transition is made. Specific operation of scenario analyzer 21

Referring to FIGS. 15-17, specific operation of the scenario analyzer 21 will now be described.

Step S121: In FIG. 15, the scenario analyzer 21 determines whether or not the total value (=9 in FIG. 15) of “degree of vacillation”, “degree of puzzle”, and “degree of anxiety” included in the input state information 54 exceeds the total specified value 61 (see “total specified value 61”=10 in FIG. 16B).

If it exceeds the total value, the process proceeds to step S122, otherwise the process proceeds to step S123.

Step S122: The scenario analyzer 21 selects the scenario for confirming the operator connection.

This selection operation will be described referring to the transition diagram of the situation shown in FIG. 17.

When the interaction proceeds to a situation S12 in FIG. 17, for example, and the input state information 54 of the user's voice exceeds the “total specified value 61”=10, the scenario analyzer 21 transitions to a situation S19 for confirming the operator connection, and selects the scenario message (“Do you want to connect to operator?”) set in the situation S19.

Hereafter, when the user's response is “Yes”, the scenario analyzer 21 transitions to the situation (not shown) of an operator transfer. When it is “No”, the scenario analyzer 21 transitions to the situation S12 and makes an inquiry about hotel guidance again.

Step S123: The scenario analyzer 21 determines whether or not there is a keyword by referring to the keyword analysis result information 50. In the presence of the keyword, the process proceeds to step S124, otherwise the process proceeds to step S127.

Step S124: The scenario analyzer 21 determines whether or not “degree of vacillation”, “degree of puzzle”, and “degree of anxiety” included in the input state information 54 respectively exceed “degree of vacillation”, “degree of puzzle”, and “degree of anxiety” prescribed in the individual specified value 60. If none of them exceeds “degree of vacillation”, “degree of puzzle”, and “degree of anxiety”, it is determined that a user has responded without “vacillation”, “puzzle”, and “anxiety”, and the process proceeds to step S125. When at least one of them exceeds any of “degree of vacillation”, “degree of puzzle”, and “degree of anxiety”, the process proceeds to step S126.

Step S125: The scenario analyzer 21 selects the scenario of the subsequent situation.

Namely, when the interaction has proceeded to the situation S12 of FIG. 17 for example, the scenario analyzer 21 proceeds to a subsequent situation S14 selected by the keyword “reservation” included in the usual keyword analysis result information 50, and selects a scenario (reservation guidance) set in the situation S12.

Step S126: The scenario analyzer 21 selects the scenario of the situation which confirms the input content for the user.

Namely, when the interaction has proceeded to the situation S12 of FIG. 17, for example, the scenario analyzer 21 selects a confirmation scenario (“Is hotel reservation O.K.?”) of a situation S16, and confirms a hotel reservation to the user.

Hereafter, when the response of the user is “Yes”, the scenario analyzer 21 transitions to the situation S14. When the response is “No”, the scenario analyzer 21 transitions to the situation S12.

Step S127: The scenario analyzer 21 determines whether or not “degree of puzzle” exceeds the individual specified value. If it exceeds the individual specified value, the process proceeds to step S128 for selecting another scenario, otherwise the process proceeds to step S129 for selecting a scenario for a detailed description.

Step S128: The scenario analyzer 21 selects a scenario message for making an inquiry about whether or not another scenario is selected.

Namely, when the interaction has proceeded to the situation S12, for example, the scenario analyzer 21 selects a scenario (“Do you want to transition to another content?”) of a situation S17 to confirm to the user whether or not another scenario is selected.

Hereafter, when the response of the user is “Yes”, the scenario analyzer 21 transitions to a situation S11. When the response is “No”, the scenario analyzer 21 transitions to the situation S12.

Step S129: The scenario analyzer 21 selects a scenario for the detailed description. Namely, when the interaction is proceeding to the situation S12 for example, the scenario analyzer 21 transitions to a situation S18 corresponding to the scenario of the detailed description, and performs the detail description of the situation S12 with the scenario message (“Now, you can select “hotel reservation” or “map guidance”).

Hereafter, the scenario analyzer 21 transitions to the situation S12 and makes an inquiry about the service selection again.

Hereafter, the scenario analyzer 21 assigns the scenario message 55 selected at the steps S125, S126, S128, and S129 to the message synthesizer 22.

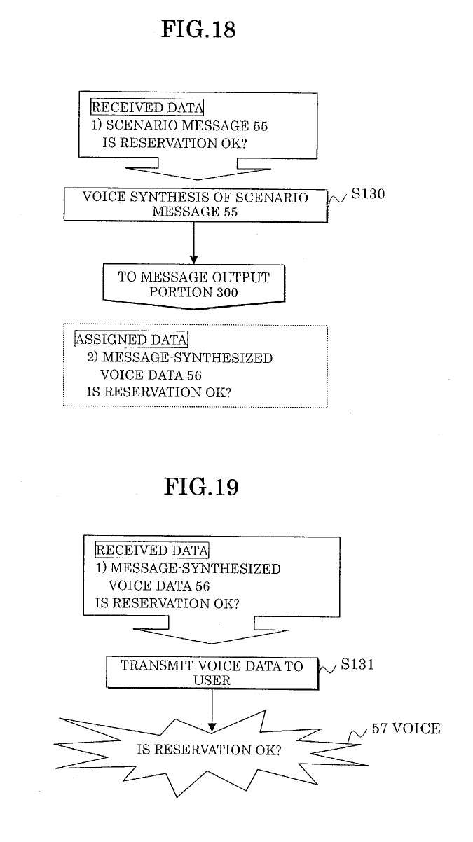

Message Synthesizer 22 (see FIG. 18)

The operation example of the message synthesizer 22 will now be described.

Step S130: The message synthesizer 22 converts the scenario message 55 into synthesized voice data 56 to be assigned to the message output portion 300.

Message Output Portion 300 (see FIG. 19)

The operation example of the message output portion 300 will now be described.

Step S131: The message output portion 300 transmits the message synthesized voice data 56 to the user.

Embodiment (2)

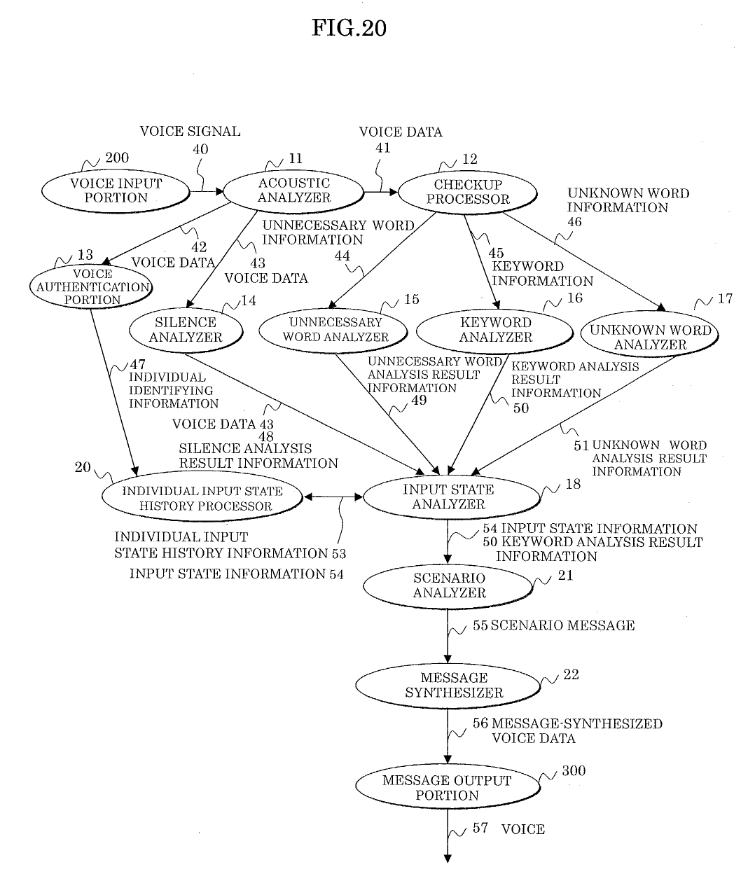

FIG. 20 shows an embodiment (2) of an operation of the voice interaction apparatus 100 according to the present invention shown in FIG. 1. The arrangement of the voice interaction apparatus 100 in this embodiment (2) precludes the overall-user input state history processor 19 in the voice interaction apparatus 100 shown in FIG. 1.

In this embodiment (2), a flow in which the acoustic analyzer 11 accesses the acoustic data 31, a flow in which the checkup processor 12 accesses the dictionary data 32, the keyword data 34, and the unnecessary word data 33, and a flow in which the individual input state history processor 20 accesses the input state history data 36 are omitted for simplifying the figure.

Together with this omission, the acoustic data 31, the dictionary data 32, the keyword data 34, the unnecessary word data 33, and the input state history data 36 are also omitted for simplifying the figure.

Hereinafter, the schematic operation of the voice interaction apparatus 100 in the embodiment (2) will be first described.

The acoustic analyzer 11 performs an acoustic analysis to the voice signal 40 inputted from the voice input portion 200 to prepare the voice data 41-43. It is to be noted that the voice data 41-43 are the same voice data.

The operations of the checkup processor 12, the silence analyzer 14, the keyword analyzer 16, the unnecessary word analyzer 15, and the unknown word analyzer 17 are the same as those of the embodiment (1).

The input state analyzer 18 performs a comprehensive analysis by using the analysis result information 48-51 respectively obtained from the silence analyzer 14, the unknown word analyzer 15, the keyword analyzer 16, and the unknown word analyzer 17, and the input state history data 36 taken out of the individual input state history processor 20, and then determines the input state of the user.

It is to be noted that although the input state history data 36 in the embodiment (2) is individual data, and is different from the input state history data 36 common to all users shown in the embodiment (1), the same reference numeral 36 is applied.

The voice authenticator 13 extracts a voice print pattern from the voice data 42, identifies an individual by referring to the individual authentication data 35 with the voice print pattern being made a key to be notified to the input state analyzer 18.

The individual input state history processor 20 responds to the inquiry of the input state history data 36 of the individual identified by the input state analyzer 18.

The input state analyzer 18 performs a comprehensive analysis by using the analysis results respectively obtained from the unnecessary word analyzer 15, the keyword analyzer 16, the unknown word analyzer 17, and the silence analyzer 14, and the input state history data 36 of an identified individual responded by the individual input state history processor 20, determines the input state of the user, and assigns the input state information 54 to the processor 20 and the scenario analyzer 21.

Also, the individual input state history processor 20 accumulates the input state information 54 of the determined individual in the input state history data 36.

The operations of the checkup processor 12, the silence analyzer 14, the keyword analyzer 16, the unnecessary word analyzer 15, the unknown word analyzer 17, the scenario analyzer 21, the message synthesizer 22, and the message output portion 300 are the same as those of the embodiment (1).

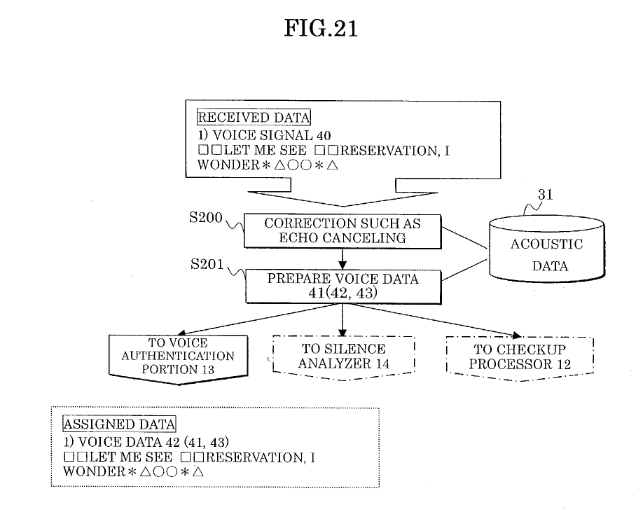

Hereinafter, more specific operation of the voice interaction apparatus 100 in the embodiment (2), especially the operations of the acoustic analyzer 11 and the voice authenticator 13 which are different from those of the embodiment (1) and operations of the input state analyzer 18 and the individual input state history processor 20 not included in the embodiment (1) will be described referring to FIGS. 21-25.

Also in this description, in the same way as the embodiment (1), “□□Let me see. □□Reservation, I wonder. *Δ◯◯*Δ” is supposed to be used as an example of the voice signal 40 inputted to the voice interaction apparatus 100.

Acoustic Analyzer 11 (see FIG. 21)

Steps S200 and S201: The acoustic analyzer 11 performs correction processing such as echo canceling to the voice signal 40 by referring to the acoustic data 31, and prepares the voice data 41-43. It is to be noted that the voice data 41-43 are the same voice data.

The acoustic analyzer 11 assigns the voice data 41-43 respectively to the checkup processor 12, the voice authenticator 13, and the silence analyzer 14.

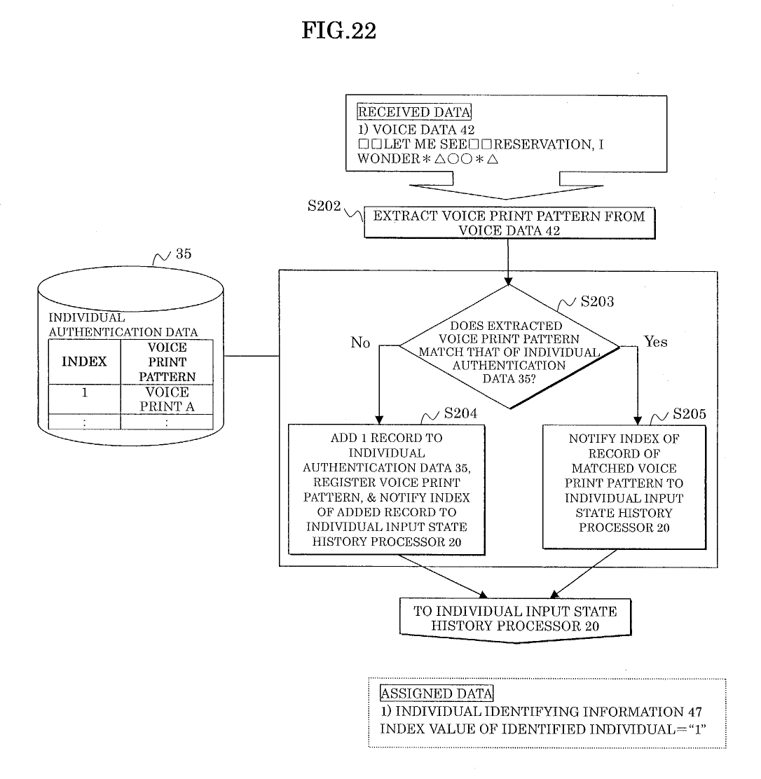

Voice Authenticator 13 (see FIG. 22)

Step S202: The voice authenticator 13 extracts a voice print pattern from the voice data 43 of the user.

Steps S203, S204, and S205: The voice authenticator 13 checks whether or not this voice print pattern is registered in the individual authentication data 35. If it is not registered, the voice authenticator 13 adds one record to the individual authentication data 35, registers the voice print pattern, and notifies an index (individual identifying information 47) of the added record to the individual input state history processor 20.

When the voice print pattern is registered, the voice authenticator 13 notifies the index (individual identifying information 47) of the voice print pattern registered to the individual input state history processor 20.

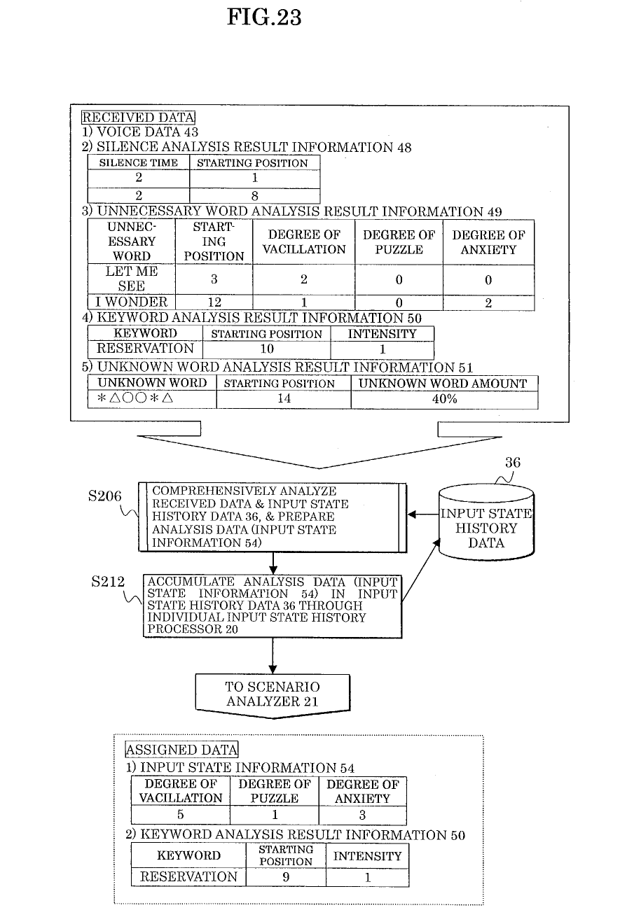

Input State Analyzer 18 (see FIG. 23)

Step S206: The input state analyzer 18 prepares analysis data (input state information 54) in which the voice data 43 received, the silence analysis result information 48, the unnecessary word analysis result information 49, the keyword analysis result information 50, the unknown word analysis result information 51, and the input state history data 36 of the identified individual received through the individual input state history processor 20 are comprehensively analyzed.

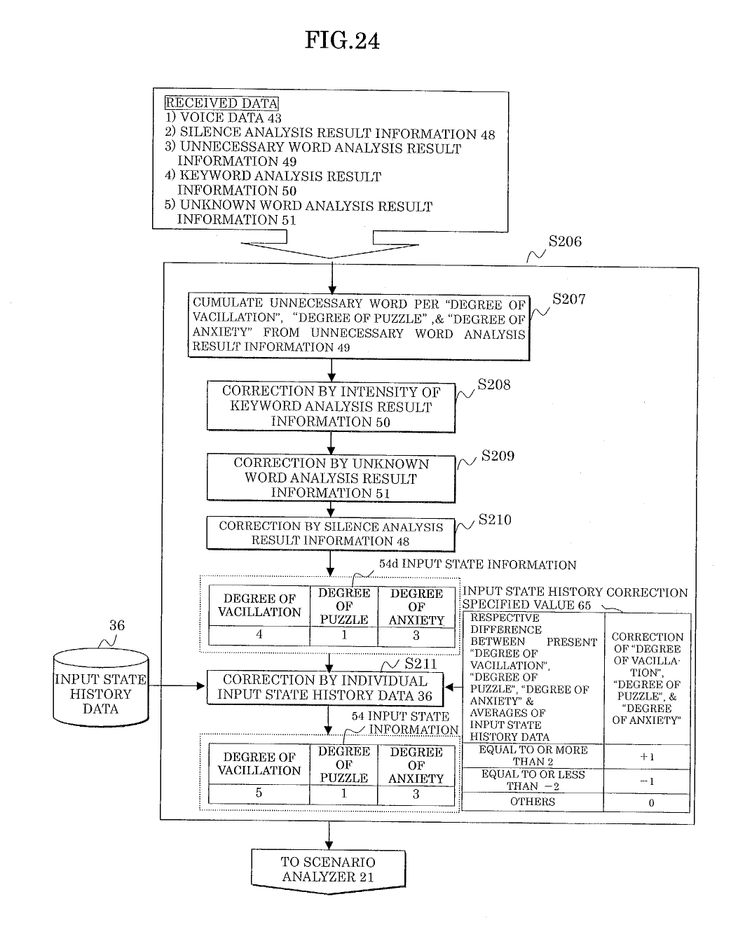

Analysis procedure steps S207-S211 shown in FIG. 24 indicate in more detail the above-mentioned analysis procedure. This analysis procedure will now be described.

Steps S207-S210: These steps are the same as steps S113-S116 of the analysis procedure shown in the embodiment (1) of FIG. 13. The input state information 54a obtained from the unnecessary word analysis result information 49 is corrected by the keyword analysis result information 50, the unknown word analysis result information 51, and the silence analysis result information 48.

The analysis result is supposed to be the input state information 54d (“degree of vacillation”=4, “degree of puzzle”=1, “degree of anxiety”=3) that is the same as the analysis result of step S116 in the embodiment (1).

Step S211: The input state analyzer 18 corrects the input state information 54d based on the individual input state history data 36 and the input state history correction specified value 65.

This correction is performed by comparing the averages of “degree of vacillation”, “degree of puzzle”, and “degree of anxiety” accumulated per individual in the input state history data 36 with the specified values 65, thereby reflecting the characteristic of the user individual.

The averages of the individual input state history data 36 are calculated per “degree of vacillation”, “degree of puzzle”, and “degree of anxiety”. These averages are supposed to be “degree of vacillation”=2, “degree of puzzle”=1, and “degree of anxiety”=2.

The input state history correction specified value 65 is the same as the specified value 65 shown in e.g. FIG. 13. The input state analyzer 18 corrects only the “degree of vacillation” by “+1” based on the above-mentioned correction reference to output the input state information (“degree of vacillation”=5, “degree of puzzle”=1, “degree of anxiety”=3).

Step S212: In FIG. 23, the input state analyzer 18 accumulates the input state information 54 per individual in the input state history data 36 through the individual input state history processor 20.

Furthermore, the input state analyzer 18 assigns the input state information 54 to the keyword analysis result information 50 and the scenario analyzer 21.

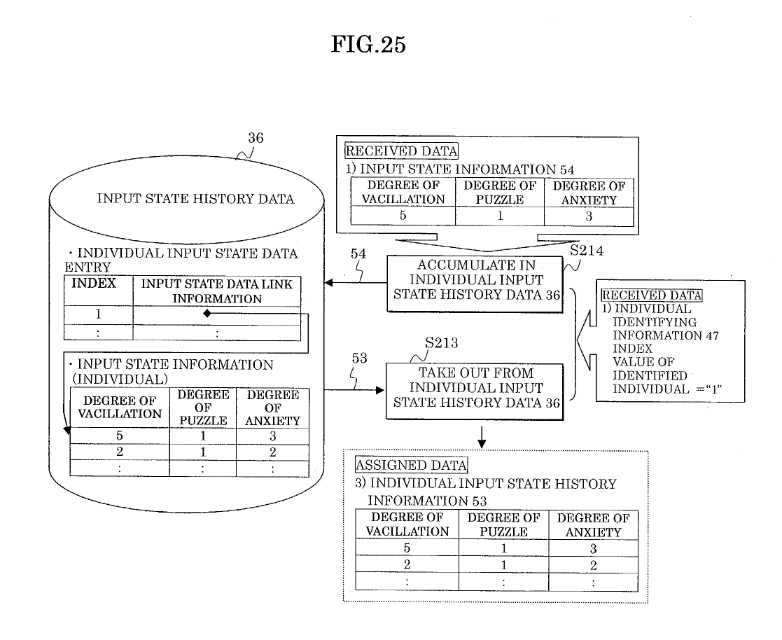

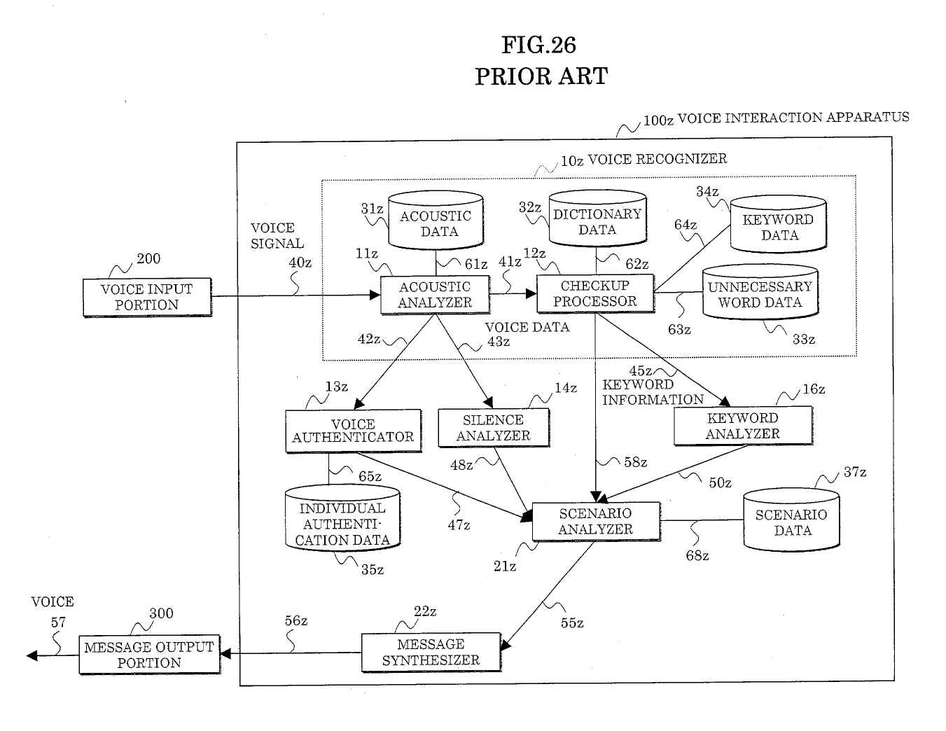

Individual Input State History Processor 20 (see FIG. 25)

More specific operation of the processor 20 at the above-mentioned steps S211 and S212 will now be described.

Step S213: The processor 20 extracts the input state history information 53 of an identified individual from the input state history data 36 based on the individual identifying information 47 to be assigned to the input state analyzer 18.

Step S214: The processor 20 accumulates the input state information 54 of the identified individual in the input state history data 36 based on the “individual identifying information 47”=“index value” received from the input state information 54 and the voice authenticator 13.

As described above, a voice interaction apparatus according to the present invention is arranged such that a voice recognizer detects an interaction response content (keywords, unnecessary words, unknown words, and silence) indicating a psychology of a voice-inputting person at a time of a voice interaction, an input state analyzer analyzes the interaction response content and classifies the psychology of the voice-inputting person into predetermined input state information, and a scenario analyzer selects a scenario for a voice-inputting person based on the input state information. Therefore, it becomes possible to perform response services corresponding to a response state of a user.

Specifically, it becomes possible to perform an interaction, with the user, corresponding to the state in which the user can not understand the interaction voice, can not be accepted by the voice interaction apparatus because of an incomplete interaction response content, can not correct an erroneous input promptly and easily, or hesitates to determine his intention.

What we claim is:

1. A voice interaction apparatus comprising:
a voice recognizer for detecting an interaction response content indicating a psychology of a voice-inputting person at a time of a voice interaction; and
an input state analyzer for analyzing the interaction response content and for classifying the psychology into predetermined input state information.

2. The voice interaction apparatus as claimed in claim 1 wherein the interaction response content comprises at least one of a keyword, an unnecessary word, an unknown word, and a silence.

3. The voice interaction apparatus as claimed in claim 2 wherein the interaction response content comprises at least one of starting positions of the keyword, the unnecessary word, the unknown word, and the silence.

4. The voice interaction apparatus as claimed in claim 1 wherein the input state information comprises at least one of vacillation, puzzle, and anxiety.

5. The voice interaction apparatus as claimed in claim 1, further comprising:
a scenario database for storing a scenario corresponding to the input state information; and
a scenario analyzer for selecting a scenario for a voice-inputting person based on the input state information.

6. The voice interaction apparatus as claimed in claim 1 wherein the voice recognizer has an unnecessary word database associating an unnecessary word indicating the psychology with unnecessary word analysis result information obtained by digitizing the psychology, and an unnecessary word analyzer for converting the unnecessary word into the unnecessary word analysis result information based on the unnecessary word database.

7. The voice interaction apparatus as claimed in claim 6 wherein the input state analyzer classifies the psychology of the voice-inputting person into the input state information based on one or more unnecessary word analysis result information.

8. The voice interaction apparatus as claimed in claim 6 wherein the voice recognizer further has a silence analyzer for detecting a silence time included in the interaction response content, and the input state analyzer corrects the input state information based on the silence time.

9. The voice interaction apparatus as claimed in claim 6 wherein the voice recognizer further has a keyword analyzer for analyzing an intensity of a keyword included in the interaction response content, and
the input state analyzer corrects the input state information based on the intensity.

10. The voice interaction apparatus as claimed in claim 6 wherein the voice recognizer further has an unknown word analyzer for detecting a ratio of unknown words included in the interaction response content to the interaction response content, and the input state analyzer corrects the input state information based on the ratio.

11. The voice interaction apparatus as claimed in claim 1, further comprising an overall-user input state history processor for accumulating the input state information in an input state history database,
the input state analyzer corrects the input state information based on the input state history database.

12. The voice interaction apparatus as claimed in claim 1, further comprising:
a voice authenticator for identifying the voice-inputting person based on the voice of the voice-inputting person; and
an individual input state history processor for accumulating the input state information per voice-inputting person in an input state history database;
the input state analyzer corrects the input state information based on the input state history database.

13. The voice interaction apparatus as claimed in claim 5 wherein the scenario analyzer further selects the scenario based on a keyword included in the interaction response content.

14. The voice interaction apparatus as claimed in claim 13 wherein the scenario includes at least one of a scenario for proceeding to a situation subsequent to a present scenario, a scenario for confirming whether or not the present scenario is acceptable, a scenario for transitioning to a scenario different from the present scenario, a scenario for describing in detail the present scenario, and a scenario for connecting to an operator.
